(19) United States
(12) Patent Application Publication
(10) Pub. No.: US 2006/0230581 A1
(43) Pub. Date: Oct. 19, 2006

(54) LOCKING MECHANISM FOR AN EXTENSION POLE

(75) Inventors: William Daniel Richardson, Greenwood, MO (US); Dwight R. Poole, Harrisonville, MO (US)

Correspondence Address: HOVEY WILLIAMS LLP, 2405 GRAND BLVD., SUITE 400, KANSAS CITY, MO, 64108, US

(73) Assignee: SPECIALTY PRODUCTS OF GREENWOOD, MISSOURI, INC., Greenwood, MO (US)

(21) Appl. No.: 10/907,793

(22) Filed: Apr. 15, 2005

(51) Int. Cl. B25G 1/04

(52) U.S. Cl. 16/429

(57) ABSTRACT

An improved extension pole (20) is provided having relatively shiftable outer and inner bodies (24, 26) with a manually operable locking mechanism (28). The mechanism (28) includes a stationary component (44) secured to outer body (24), with a bidirectionally rotatable component (46) supported on the component (44). The rotatable component (46) has a projecting locking segment (60) disposed about the inner body (24), with the segment (60) being offset. When the mechanism (28) is in its unlocked condition, the centerline of the segment (60) is substantially coincident with the centerlines of the inner and outer bodies (24, 26), thereby permitting free reciprocation of body (26); upon rotation of the component (46), the locking segment (60) comes into direct, frictional, locking engagement with the inner body (26) along a contact arc (68).

### BACKGROUND OF THE INVENTION

1. Field of the Invention

The present invention is broadly concerned with extension poles having at least a pair of telescopically interfitted bodies allowing the length of the pole to be adjusted by the user. More particularly, the invention is concerned with such extension poles having an improved, bidirectionally operable locking mechanism coupled between the relatively shiftable bodies and which allows the user to easily and quickly engage and disengage the locking mechanism using only a minimum of physical effort.

2. Description of the Prior Art

Tool-supporting extension poles are used to extend the reach of a user for the application of a tool, such as a paint roller, to hard-to-reach locations, such as a ceiling or the upper portion of a wall. Generally speaking, these prior poles have included an outer tubular section with an inner section telescoped within the outer section and selectively shiftable relative thereto. Such poles also are usually equipped with a user-operated locking mechanism allowing the user to unlock the mechanism, shift the inner body relative to the outer body to the desired extent, and then to lock the mechanism, thereby locking the bodies in the extended position.

A typical extension pole of the prior art is described in U.S. Pat. No. 5,220,707. In this case, a pin-type locking mechanism is provided having a spring-loaded, releasable pin for locking the pole sections. However, this type of locking mechanism fails to provide infinite adjustability. It is also known to provide a telescopic extension pole assembly with a locking mechanism having a cam assembly that presents a plurality of locking arms engageable by a rotatable cam. The locking arms are spaced circumferentially about the inner slider and forced into frictional “holding” engagement with the slider by the cam. This type of locking mechanism has been found to be deficient because it requires considerable manual force to move the mechanism between the locked and unlocked positions thereof. This construction can also be problematic because a user may not apply sufficient force to fully lock the pole in a selected extended position, and consequently the pole may unexpectedly collapse during use.

### SUMMARY OF THE INVENTION

The present invention overcomes the problems outlined above and provides an improved extension pole having an easy-to-operate locking mechanism requiring only a minimum of hand force to effect operation thereof, while at the same time effecting a secure pole lock. According to one aspect of the present invention, the extension pole includes an elongated outer tubular body and an elongated inner body telescoped within the outer body. The inner body is shiftable relative to the outer body in order to vary the length of the pole. The pole also includes a locking mechanism that comprises a stationary component secured to the outer body and a shiftable component. The shiftable component has a mounting segment disposed about the stationary component, and a locking segment extending from the mounting segment and proximal to the inner body. The locking mechanism being in an unlocked condition thereof to permit relative shiftable movement between the inner and outer bodies. The locking mechanism being placed in a locked condition upon shifting of the shiftable component to cause the locking segment to engage the inner body and thereby hold the inner body relative to the outer tubular body.

In another aspect of the invention, the extension pole includes an elongated outer tubular body and an elongated inner body telescoped within the outer body. The bodies are relatively shiftable along a pole axis in order to vary the length of the pole. The pole also includes a locking mechanism operable to selectively prevent relative shifting of the bodies. The locking mechanism includes a shiftable component positionable in a locked position, in which movement of the bodies is prevented, and an unlocked position, in which relative shifting of the bodies is permitted. The shiftable component of the locking mechanism includes a locking segment that is fixed axially relative to a first one of the bodies, such that a second one of the bodies is axially shiftable relative to the locking segment. The second one of the bodies includes a body surface that presents a centerline that is at least substantially coaxial with the pole axis. The locking segment includes a segment surface that presents a centerline, with the segment surface extending at least partly around the body surface of the second one of the bodies. The centerline of the locking segment is substantially aligned with the pole axis when the shiftable component is in said unlocked position thereof. On the other hand, when the shiftable component is in the locked position, the centerline of the locking segment is moved to an offset position relative to the pole axis, such that the locking segment engages the second one of the bodies and thereby prevents relative shifting of the bodies.

Yet another aspect of the present invention concerns an extension pole including an elongated outer tubular body and an elongated inner body telescoped within the outer body. The bodies are relatively shiftable along a pole axis in order to vary the length of the pole. The pole also includes a locking mechanism operable to selectively prevent relative shifting of the bodies. The locking mechanism includes a stationary component secured to a first one of the bodies and a relatively rotatable component positionable in a locked position, in which movement of the bodies is prevented, and an unlocked position, in which relative shifting of the bodies is permitted. The second one of the bodies and at least one of the first body and the stationary component present slidably engaging, axially extending surfaces. The surfaces have complemental segmented circular shapes including at least one arcuate section and at least one chord section, such that relative rotation between the bodies is prevented.

Other aspects and advantages of the present invention will be apparent from the following detailed description of the preferred embodiments and the accompanying drawing figures.

### BRIEF DESCRIPTION OF THE DRAWINGS

Preferred embodiments of the invention are described in detail below with reference to the attached drawing figures, wherein:

FIG. 1 is an elevation view of an extension pole constructed in accordance with a first embodiment of the invention, particularly illustrating the locking mechanism in an unlocked condition thereof and the pole supporting a typical tool such as a paint roller;

FIG. 2 is a sectional view taken along line 2-2 of FIG. 1;

FIG. 3 is a sectional view taken along line 3-3 of FIG. 1;

FIG. 4a is a fragmentary, sectional isometric view of the extension pole, illustrating the locking mechanism in the locked condition thereof;

FIG. 4b is an isometric view similar to that of FIG. 4a, but illustrating the locking mechanism in an unlocked condition upon rotation of the shiftable component forming a part of the locking mechanism and the inner slider body having been retracted within the outer body;

FIG. 4c is an isometric view similar to that of FIGS. 4a and 4b, again depicting the locking mechanism in the locked condition thereof;

FIG. 5 is a sectional view of the extension pole, taken along line 5-5 of FIGS. 6 and 7, and depicting the condition of the locking mechanism in the unlocked condition thereof;

FIG. 6 is a sectional view taken along line 6-6 of FIG. 5;

FIG. 7 is a sectional view taken along line 7-7 of FIG. 5;

FIG. 7a is an enlarged schematic view illustrating the relative position of component centerlines in the unlocked condition of the locking mechanism;

FIG. 8 is a fragmentary sectional view taken along line 8-8 of FIGS. 9 and 10, and depicting the condition of the locking mechanism in the locked condition thereof;

FIG. 9 is a sectional view taken along line 9-9 of FIG. 8;

FIG. 10 is a sectional view taken along line 10-10 of FIG. 8;

FIG. 10a is an enlarged schematic view illustrating the relative position of component centerlines in the locked condition of the locking mechanism;

FIG. 11 is a fragmentary perspective exploded view of an extension pole constructed in accordance with an alternative embodiment of the invention, particularly illustrating the segmented circular shape of the outer surface of the inner slider pole section and the complemental shape of the inner surface of the stationary component of the locking mechanism;

FIG. 12 is a cross-sectional view of the pole depicted in FIG. 11; and

FIG. 13 is an end elevation view of the locking mechanism of the pole shown in FIGS. 11 and 12, but with the slider pole section being removed to clearly depict the inner circular surface of the locking segment of the locking mechanism.

### DETAILED DESCRIPTION OF THE PREFERRED EMBODIMENT

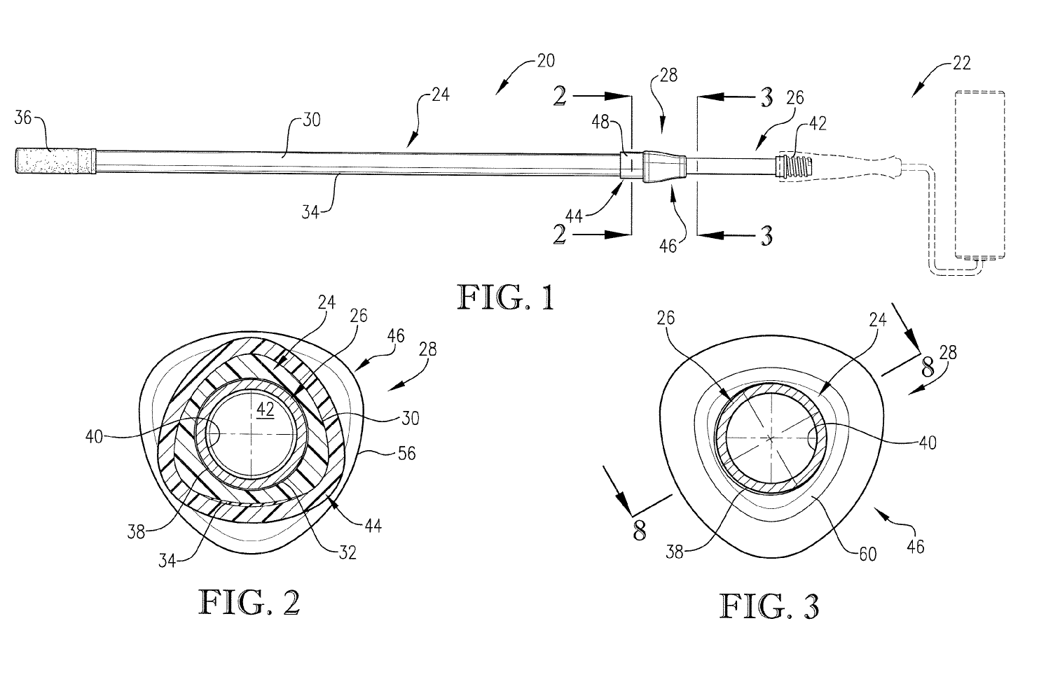

Turning now to the drawings, FIG. 1 illustrates an extension pole 20 in accordance with the invention, shown supporting an exemplary working tool, in this case a paint roller 22. It will be understood that the pole 20 can be used with a variety of different tools, well known to those skilled in the art.

Broadly speaking, the pole 20 includes an elongated outer tubular body 24, an elongated inner body 26 telescopically received within body 24, and a locking mechanism 28 operatively coupled to the poles sections 24, 26. As explained in more detail hereinafter, the pole 20 is designed to allow the user to quickly and easily adjust the effective length of the pole 20 as desired, while also assuring that the pole in its extended position is securely locked against inadvertent collapse.

In more detail, the outer body 24 is in the form of an elongated tube. The illustrated body 24 preferably presents a polygonal (i.e., somewhat triangular) outer gripping surface 30 with a circular central bore 32. However, those ordinarily skilled in the art will appreciate that the principles of the present invention are equally applicable to other body configurations (e.g., a body with an outer surface having a circular or teardrop shape). The core of the body 24 is most preferably formed of fiberglass and polypropylene binding material, while the outer surface presents a hard, smooth exterior section (e.g., preferably formed of polypropylene) extending along and bounding an elongated elastomeric strip 34 of a grip-enhancing material (e.g., TPE material). The strip 34 preferably extends substantially along the entirety of the length of the body 24. Moreover, the strip 34 is preferably softer than the remaining exterior section of the outer body 24. Again, the principles of the present invention do not require such a construction. As viewed in FIG. 1, it will be seen that the body 24 preferably has an endmost handle-type grip 36 defining the end of the body remote from locking mechanism 28.

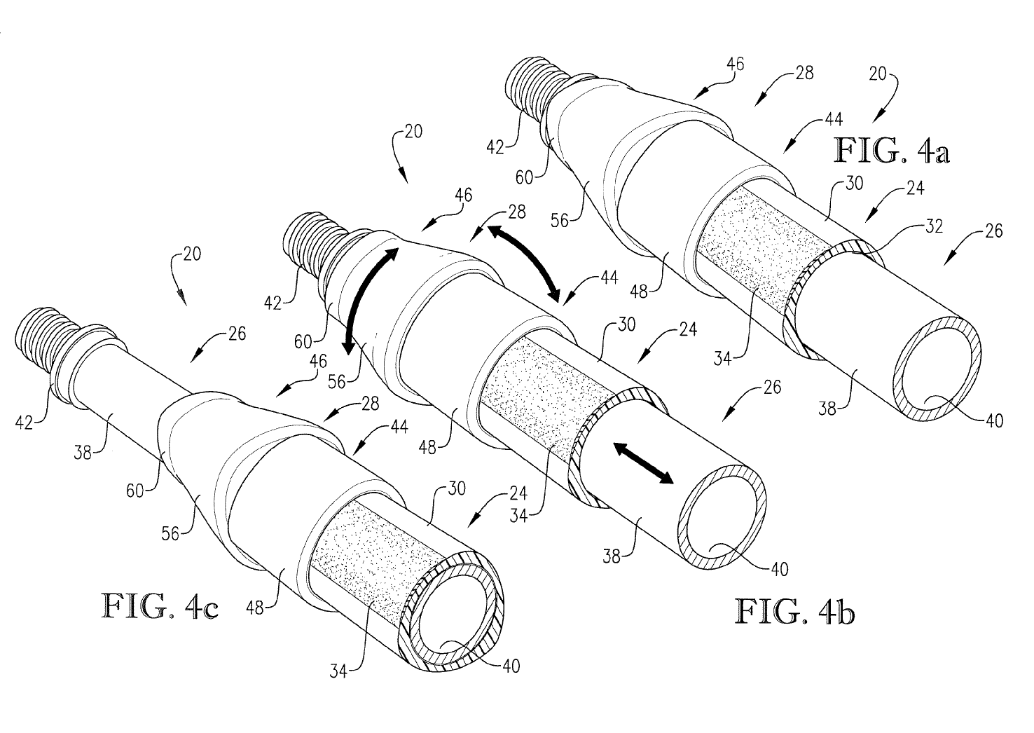

The inner body 26 is preferably though not necessarily of tubular design, and is normally formed as an aluminum extrusion, although other suitable materials and fabrication techniques are within the scope of the present invention. The body 26 has an outer surface 38 and a corresponding inner surface 40. The outermost end of the body 26 has a threaded connection fixture 42 secured thereto which permits threaded attachment of operating tools, such as the paint roller 22 (see FIG. 1). Other suitable tool connectors may be employed with the illustrated pole 10. As will be appreciated from a consideration of FIGS. 4a-4c, the inner tubular body 26 is sized relative to the circular bore 32 of body 24, so as to permit smooth, reciprocal relative shifting movement between the pole bodies 24, 26. In other words, the outer surface 38 of the slider 26 and the bore 32 of the body 24 are concentric and define respective centerlines that are at least substantially coaxial. The aligned centerlines present a pole axis along which the bodies 24 and 26 shift relative to one another.

The locking mechanism 28 preferably includes a stationary component 44 mounted upon body 24 as well as a shiftable cam-type component 46 supported on the component 44. The mechanism 28 is selectively and manually shiftable between a locking condition securely locking the bodies 24, 26 in a selected extended position, and an unlocked condition permitting free relative shifting between the bodies.

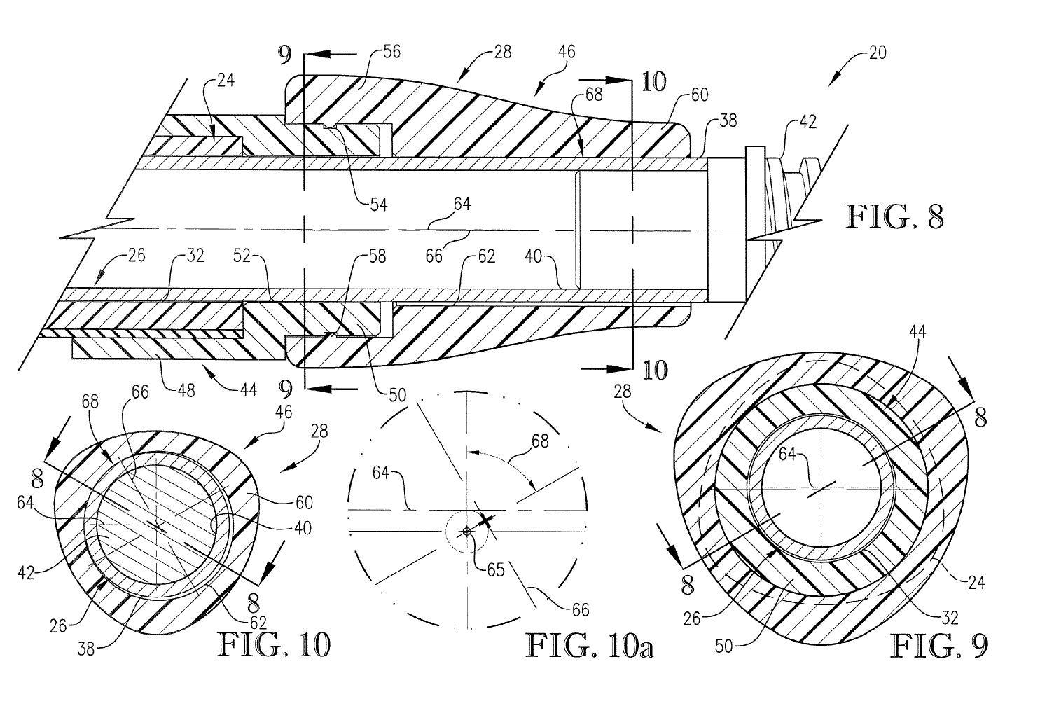

Specifically, the stationary component 44 is fixedly connected to the butt end of body 24 remote from grip 36. To this end, the component 44 has a skirt segment 48 which surrounds the end of body 24 and is secured thereto by means of adhesive or other suitable mechanical connection such as a pin or threaded fastener. Additionally, the component 44 includes an axially projecting segment 50 having a circular inner bore 52 to slidably receive the inner pole body 26. As best seen in FIGS. 7 and 8, the outer surface of segment 50 includes a peripheral locking recess 54. The outer surface of the segment 50 is preferably circular in shape, with the upper thickness 50a of the segment 50 being slightly less than the lower thickness 50b thereof, as perhaps can be best observed in FIG. 6. That is to say, the outer surface of the segment 50 is slightly eccentric relative to the outer surface 38 of the inner body 26.

The shiftable component 46 has a tubular mounting segment 56 disposed about segment 50 of component 44; the inner surface of mounting segment 56 is equipped with an inwardly projecting boss 58 which is received within recess 54 so as to permit rotation of the component 46 relative to component 44. At the same time, this interlock assures that there is no axial separation of the components 44, 46. The overall segment 46 also has an outwardly projecting tubular locking segment 60 which has a circular bore 62 to accommodate inner body 26.

The shiftable component 46 is designed with a slight offset between the centerlines and central axes of the mounting segment 56 and locking segment 60. This offset is essentially the same distance as the offset between the centerline of the outer surface of the segment 50 (essentially the same centerline for the inner surface of the mounting segment 56) and the sliding axis for the inner body 26. Moreover, this offset is preferably on the order of from about 0.005-0.050 inches, and is most preferably about 0.020 inches. The offsetting (or eccentric) relationships provided by the segment 50 and between the segments 56 and 60 account for the ability of the mechanism 28 to effect a secure, locked connection between the bodies 24, 26 upon appropriate rotation of the component 46.

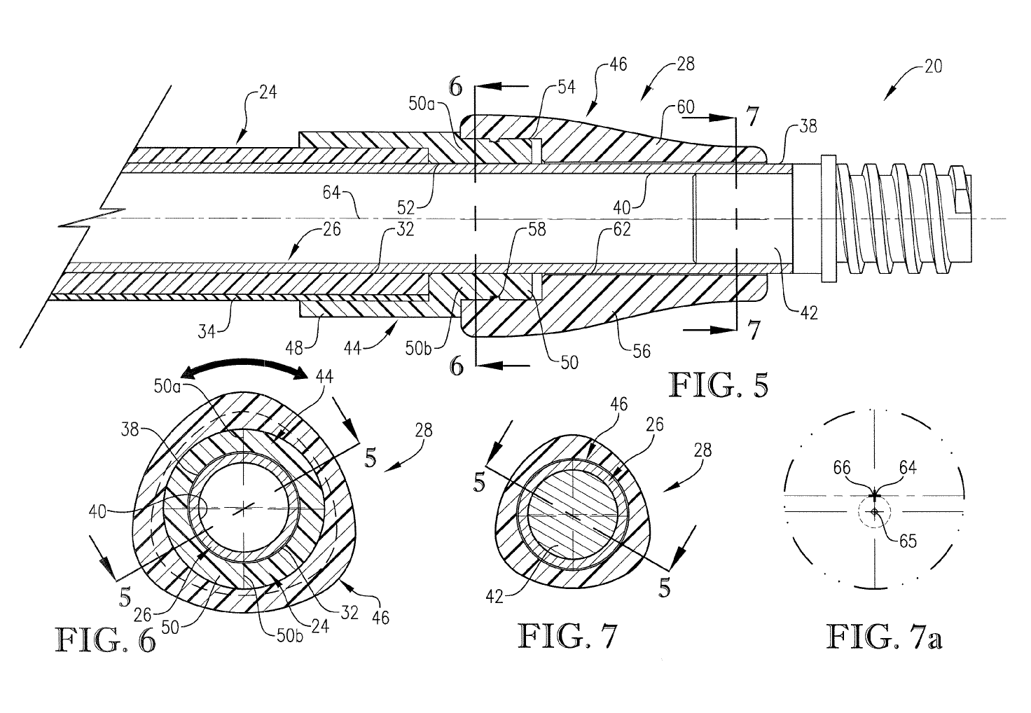

In greater detail, the pole 20 is designed so that the centerlines and central axes of the outer body 24, inner body 26 and the skirt segment 48 of stationary component 44 are essentially coincident at all times. This can be observed in FIG. 5 where the centerline 64 represents these coincident lines and axes. The centerline for the outer surface of the segment 50 of the stationary component 44 (essentially the same centerline for the inner surface of the mounting segment 56 of the shiftable component 46) is represented by the reference numeral 65. The centerline 65 is continuously offset from the centerline 64, and the centerline 66 (or central axis) of the inner surface of the locking segment 60 consequently rotates around the centerline 65—into and out of alignment with the centerline 64. In the unlocked condition of mechanism 28 shown in FIGS. 5-7a, the centerline 66 of the locking segment 60 of shiftable component 46 is essentially coincident with the line 64. As such, the inner body 26 is freely shiftable relative to the outer body 24 and mechanism 28.

Upon rotation of the component 46 in either direction through an arc of about 60°, the centerline 66 of the locking segment 60 assumes an offset relationship relative to the centerline 64, resulting in functional engagement between the inner bore 62 of locking segment 60 and the outer surface 38 of inner body 26. This condition is illustrated in FIGS. 8-10a, along an arc 68 (see FIG. 10). Those ordinarily skilled in the art will appreciate, however, that the degree the shiftable component 46 must rotate to place the locking mechanism in the locked condition may be varied.

It will thus be appreciated that the use and operation of pole 20 is extremely simple, requiring only a minimum of physical effort. Referring to FIGS. 4a-4c, FIG. 4a illustrates the pole 20 in a collapsed position with the mechanism 28 in its locked condition. FIG. 4b illustrates a situation where the user has grasped the component 46 and has rotated the same in either direction (as illustrated by the bidirectional arrows) to the unlocked condition of the mechanism 28. At this point the inner body 26 can be axially shifted relative to the outer body 24 to a desired extended position. Next, the user rotates component 46 in either direction until the mechanism 28 again assumes the locked condition where the segment 60 comes into direct, locking engagement with inner body 26. It is believed that such engagement between the segment 60 and the inner body 26 causes the inner body to be slightly deflected, with the deflected section of the inner body 26 being slightly misaligned relative to the pole sliding axis, thereby preventing relative shifting of the bodies 24 and 26. Of course, the frictional interengagement between the segment 60 and body 26 also serves to hold the body 26 from shifting relative to the body 24.

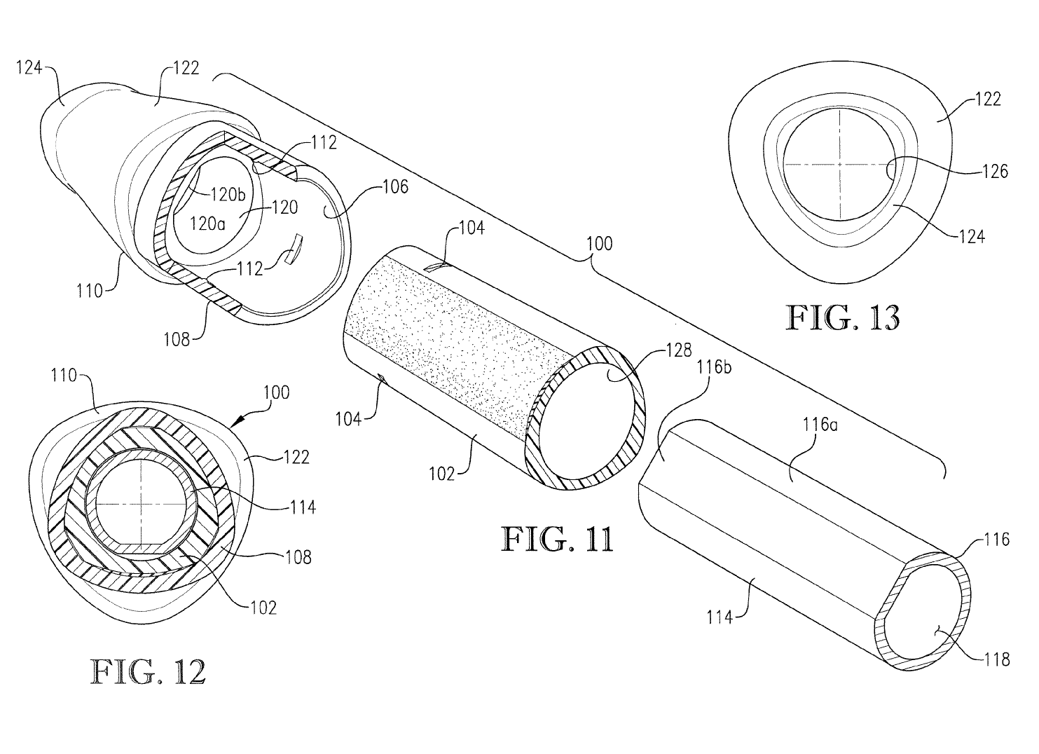

An alternative embodiment of the present invention is depicted in FIGS. 11-13, wherein the extension pole 100 has a construction very similar to that of the pole 20 depicted in FIGS. 1-10. Therefore, it shall be sufficient to describe the pole 100 principally with respect to its structural and functional differences.

More particularly, the outer body 102 of the pole 100 presents three equally spaced apart grooves 104 (only two of the grooves 104 being shown in the drawings) that extend perpendicular relative to the pole axis. As before, the outer body 102 preferably presents a generally triangular shape, and the illustrated grooves 104 are located on the angles (or lobes) of the body 102. Each of the grooves 104 extends along the circumference of the outer body 102 approximately one-half of an inch and axially about one-eighth of an inch. The maximum depth of the preferred groove is about thirty-thousandths of an inch.

The inner surface 106 of the stationary component 108 of the lock mechanism 110, which receives the end portion of the outer body 102, presents three complemental ribs 112. Each of the ribs 112 is appropriately spaced and sized to snap into a corresponding one of the grooves 104. The ribs 112 preferably have the same length of the grooves 104; however, the width of each rib is approximately one-tenth of an inch and the height is about twenty-five thousandths of an inch. That is, the ribs 112 are slightly undersized relative to the grooves 104.

It has been determined that this arrangement provides for simple but secure connection between the outer body 102 and stationary component 108. However, the principles of the present invention are equally applicable to alternative rib-and-groove type connections. For example, some or all of the ribs may alternatively be provided on the outer body, such that some or all of the grooves are provided on the stationary component. It is also possible to provide more or less rib-and-groove connections than shown, although at least three (3) such connections as shown is most desirable. It is noteworthy, however, that the grooves and ribs most preferably extend circumferentially around the pole.

Contrary to the embodiment depicted in FIGS. 1-10, the inner slider 114 presents an outer surface 116 with a segmented circular shape. The illustrated outer surface 116 includes an arcuate section 116a and a chord section 116b. The illustrated inner body 114 is tubular, and the inner surface 118 thereof has the same shape of the outer surface 116. It will be appreciated, however, that the principles of the present invention are equally applicable to an inner body with an inner surface having a different shape than the outer surface or an inner body that is solid (and presents no inner surface). The stationary component 108 presents an inner surface 120 that slidably engages the outer surface 116 of the slider 114. Moreover, the inner surface 120 has a segmented circular shape that complements that of the outer slider surface 116. In particular, the inner surface 120 includes an arcuate section 120a and a chord section 120b. Because the stationary component 108 is axially and rotatably fixed relative to the outer pole body 102, the segmented circular shapes of the surfaces 114 and 120 serve to prevent relative rotation between the bodies 102 and 114.

It has been determined that the illustrated arrangement for restricting relative rotation between the bodies 114 and 120 is particularly advantageous relative to prior art configurations. Specifically, the segmented circular shape of the surfaces 114 and 120 provides a relatively smooth outer face that is not likely to collect paint or other debris that might otherwise collect in small crevices or openings. Furthermore, the illustrated locking mechanism 110 utilizes a rotatable component 122 that shifts between unlocked and locked positions (similar to the component 46 of the first embodiment depicted in FIGS. 1-10). Moreover, the locking segment 124 of the component 122 presents a circular inner surface 126 that cooperates with the outer surface 116 of the inner pole body 114 to lock the pole 100 in the desired extended position. The construction of the illustrated pole 100 therefore requires that the surfaces 116 and 126 be capable of rotating relative to one another and also contacting one another to provide locking as desired.

The surfaces 116 and 120 are most preferably identical in shape with the latter being slightly larger than the former. In addition, each of the surfaces 116,120 includes one arcuate section 116a,120a and one chord section 116b,120b. However, it is within the ambit of the present invention to alternatively provide the surfaces 116,120 with multiple arcuate sections and multiple chord sections. Furthermore, the principles of the present invention are equally applicable to surfaces 116,120 that do not have an equal number of arcuate and chord sections. For example, the surface 116 may alternatively be provided with two or more chord sections, as long as one of the sections sufficiently engages the chord section 120b of the surface 120 to provide the desired restriction on relative rotation. In any case, the arcuate section (or sections) of each of the surfaces 116,120 preferably extends around at least about 50% of the circumference thereof (i.e., each of the surfaces 116,120 have an arcuate section(s) corresponding to an aggregate central angle of at least about 180°). Most preferably, the arcuate section (or sections) of each of the surfaces 116,120 makes up at least about 65% of the circumference thereof (i.e., each of the surfaces 116,120 have an arcuate section(s) corresponding to an aggregate central angle of at least about 230°). Yet further, each of the surfaces 116,120 preferably has no more than three arcuate or chord sections. It is also noted that the inside surface 128 of the outer body 102 may alternatively or additionally have the segmented circular shape to restrict relative rotation of the inner body 114.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. An extension pole comprising:
an elongated outer tubular body;
an elongated inner body telescoped within the outer body and shiftable relative thereto in order to vary the length of the pole; and
a locking mechanism including a stationary component secured to said outer body and a shiftable component,
said shiftable component having a mounting segment disposed about said stationary component, and a locking segment extending from said mounting segment and proximal to said inner body,
said locking mechanism in an unlocked condition thereof permitting relative shiftable movement between the inner and outer bodies,
said locking mechanism being placed in a locked condition upon shifting of said shiftable component to cause said locking segment to engage said inner body and thereby hold the inner body relative to the outer tubular body.

2. The extension pole as claimed in claim 1,
said shiftable component being rotatable relative to said stationary component.

3. The extension pole as claimed in claim 2,
said inner body and at least one of said outer body and said stationary component presenting slidably engaging, axially extending surfaces,
said surfaces having complemental segmented circular shapes including at least one arcuate section and at least one chord section, such that relative rotation between the bodies is prevented.

4. The extension pole as claimed in claim 1,
said shiftable component being mounted on said stationary component for bidirectional rotation of the shiftable component.

5. The extension pole as claimed in claim 1,
said stationary and shiftable components being tubular.

6. The extension pole as claimed in claim 1,
said mounting and locking segments being tubular, the centerline of said mounting segment being offset a distance from the centerline of said locking segment.

7. The extension pole as claimed in claim 6,
said offset distance being from about 0.005-0.050 inches.

8. The extension pole as claimed in claim 6,
said centerline of said locking segment being essentially the same as the centerline of said inner body when said locking mechanism is in said unlocked condition thereof, the centerline of said locking segment being moved to an offset position relative to the centerline of said inner body when said locking mechanism is in said locked condition thereof, whereby the inner surface of said locking segment engages the outer surface of said inner body.

9. The extension pole as claimed in claim 6; and
a connector operably coupling said mounting segment and said stationary component to permit shifting of the mounting segment relative to the stationary component while preventing axial separation of the mounting segment and stationary component.

10. The extension pole as claimed in claim 9,
said connector comprising a mechanical interlock between said stationary component and said mounting segment.

11. The extension pole as claimed in claim 1,
one of said outer body and said stationary component including a plurality of spaced apart circumferentially extending grooves and the other including a plurality of complementary ribs, each of which is received within a corresponding one of the grooves, to thereby fixedly interconnect the outer body and stationary component.

12. An extension pole comprising:
an elongated outer tubular body;
an elongated inner body telescoped within the outer body, with the bodies being relatively shiftable along a pole axis in order to vary the length of the pole; and
a locking mechanism operable to selectively prevent relative shifting of the bodies,
said locking mechanism including a shiftable component positionable in a locked position, in which movement of the bodies is prevented, and an unlocked position, in which relative shifting of the bodies is permitted,
said shiftable component including a locking segment that is fixed axially relative to a first one of the bodies, such that a second one of the bodies is axially shiftable relative to the locking segment,
said second one of the bodies including a body surface that presents a centerline that is at least substantially coaxial with the pole axis,
said locking segment including a segment surface that presents a centerline, with the segment surface extending at least partly around the body surface of said second one of the bodies,
said centerline of the locking segment being substantially aligned with the pole axis when the shiftable component is in said unlocked position thereof,
said centerline of the locking segment being moved to an offset position relative to the pole axis when the shiftable component is in said locked position thereof, with the locking segment thereby engaging said second one of the bodies to prevent relative shifting of the bodies.

13. The extension pole as claimed in claim 12,
said first one of the bodies being the outer body, and said second one of the bodies being the inner body.

14. The extension pole as claimed in claim 12,
said locking segment being tubular and receiving the second one of the bodies therein,
said body surface comprising an outer surface of the second one of the bodies, and the segment surface comprising an inner surface of the locking segment,
said inner and outer surfaces being circular, with the inner surface being continuous and extending completely around the outer surface.

15. The extension pole as claimed in claim 12,
said shiftable component being rotatable about the pole axis.

16. The extension pole as claimed in claim 15,
said locking mechanism including a stationary component secured to said first one of the bodies,
said second one of said bodies and at least one of said first one of said bodies and said stationary component presenting slidably engaging, axially extending surfaces,
said surfaces having complemental segmented circular shapes including at least one arcuate section and at least one chord section, such that relative rotation between the bodies is prevented.

17. The extension pole as claimed in claim 12,
said locking mechanism including a stationary component secured to said first one of the bodies,
said shiftable component having a mounting segment disposed about said stationary component, with the locking segment extending from the mounting segment.

18. The extension pole as claimed in claim 17,
said shiftable component being mounted on said stationary component for bidirectional rotation of the shiftable component.

19. The extension pole as claimed in claim 17,
said stationary and shiftable components being tubular.

20. The extension pole as claimed in claim 17,
said mounting and locking segments being tubular,
said mounting segment presenting a centerline that is offset a distance from the centerline of said locking segment.

21. The extension pole as claimed in claim 20,
said offset distance being from about 0.005-0.050 inches.

22. The extension pole as claimed in claim 17; and
a connector operably coupling said mounting segment and said stationary component to permit shifting of the mounting segment relative to the stationary component while preventing axial separation of the mounting segment and stationary component.

23. The extension pole as claimed in claim 22,
said connector comprising a mechanical interlock between said stationary component and said mounting segment.

24. The extension pole as claimed in claim 12,
said locking mechanism including a stationary component secured to said first one of the bodies,
said first one of said bodies and said stationary component including a plurality of spaced apart circumferentially extending grooves and the other including a plurality of complementary ribs, each of which is received within a corresponding one of the grooves, to thereby fixedly interconnect the first one of said bodies and stationary component.

25. An extension pole comprising:
an elongated outer tubular body;
an elongated inner body telescoped within the outer body, with the bodies being relatively shiftable along a pole axis in order to vary the length of the pole; and
a locking mechanism operable to selectively prevent relative shifting of the bodies,
said locking mechanism including a stationary component secured to a first one of said bodies and a relatively rotatable component positionable in a locked position, in which movement of the bodies is prevented, and an unlocked position, in which relative shifting of the bodies is permitted,
a second one of said bodies and at least one of said first one of said bodies and said stationary component presenting slidably engaging, axially extending surfaces,
said surfaces having complemental segmented circular shapes, each including at least one arcuate section and at least one chord section, such that relative rotation between the bodies is prevented.

26. The extension pole as claimed in claim 25,
said shapes of the surfaces including equal number chord sections and arcuate sections.

27. The extension pole as claimed in claim 25,
said arcuate section corresponding to a central angle of at least about 180°.

28. The extension pole as claimed in claim 27,
said central angle being at least about 230°.

29. The extension pole as claimed in claim 25,
said shapes each including only one chord section.

30. The extension pole as claimed in claim 25,
said rotatable component including a locking segment that is fixed axially relative to the first one of the bodies, such that the second one of the bodies is axially shiftable relative to the locking segment,
said surface of the second one of the bodies comprising the outer surface thereof and presenting a centerline that is at least substantially coaxial with the pole axis,
said locking segment including an inner surface that presents a centerline, with the inner surface extending at least partly around the outer surface of the second one of the bodies,
said centerline of the locking segment being substantially aligned with the pole axis when the rotatable component is in said unlocked position thereof,
said centerline of the locking segment being moved to an offset position relative to the pole axis when the rotatable component is in said locked position thereof, with the locking segment thereby engaging said second one of the bodies to prevent relative shifting of the bodies.

31. The extension pole as claimed in claim 30,
said first one of the bodies being the outer body, and said second one of the bodies being the inner body.

32. The extension pole as claimed in claim 31,
said stationary component being tubular and presenting an inside surface,
said inside surface comprising the segmented circular surface which slidably engages the outer surface of the inner body.

33. The extension pole as claimed in claim 30,
said inner surface being circular in shape and extending continuously and completely around the outer surface.

34. The extension pole as claimed in claim 30,
said rotatable component having a mounting segment disposed about said stationary component, with the locking segment extending from the mounting segment,
said mounting and locking segments being tubular,
said mounting segment presenting a centerline that is offset a distance from the centerline of said locking segment.

35. The extension pole as claimed in claim 34,
said offset distance being from about 0.005-0.050 inches.

36. The extension pole as claimed in claim 25,
said first one of said bodies and said stationary component including a plurality of spaced apart circumferentially extending grooves and the other including a plurality of complementary ribs, each of which is received within a corresponding one of the grooves, to thereby fixedly interconnect the first one of said bodies and stationary component.
